(19) United States
(12) Patent Application Publication
(10) Pub. No.: US 2014/0314966 A1
(43) Pub. Date: Oct. 23, 2014

(54) Sintering Metallic Inks on Low Melting Point Substrates

(71) Applicant: APPLIED NANOTECH HOLDINGS, INC., Austin, TX (US)

(72) Inventors: Richard Lee Fink, Austin, TX (US); James P. Novak, Austin, TX (US); Valerie Ginsberg, Austin, TX (US)

(21) Appl. No.: 14/348,846

(22) PCT Filed: Oct. 5, 2012
(86) PCT No.: PCT/US12/58836

§ 371 Date: Apr. 9, 2014

Related U.S. Application Data
(60) Provisional application No. 61/543,557, filed on Oct. 5, 2011.

(51) Int. Cl. H01B 13/00

(52) U.S. Cl. CPC H01B 13/003
USPC 427/559; 427/553

(57) ABSTRACT

Tape lamination on a dry copper ink film, followed by a flash lamp procedure, produces conductive films. The tape lamination increases the curing parameter window and reduces crack formation in the metallic film Tape lamination facilitates curing of a continuous copper film on temperature sensitive substrates, such as PET, at power levels that would usually crack blow off the copper film This lamination process also improves adhesion and uniformity of the cured film.

This application claims priority to U.S. Provisional Patent Application Ser. No. 61/543,557, which is hereby incorporated by reference heroin.

### BACKGROUND AND SUMMARY

Sintering copper ink or paste films applied to low melting point flexible films (e.g., PET, PEN), is problematic, since the substrate material would be thermally damaged at typical copper sintering temperatures. Photosintering (or photonic “flash lamp” sintering) can be used to create conductive films from metallic nanoparticles. Photosintering is a process whereby nanoparticles are exposed to a high-intensity light, the nanoparticles absorb the light and convert the energy to heat, and the particles begin to melt, assuming an energy threshold required to increase the temperature above their melting, point is achieved. Photosintering can be accomplished using broad band (such as produced by a Xe-arc discharge lamp or coherent light (such as produced by a laser) sources. The photosintering process is extremely fast, usually occurring in sub-millisecond time scales. The process of energy conversion can be considered rapid and violent with respect to the energy level of the nanoparticles. Determining the correct parameters to obtain a sintered, continuous, copper film, with photonic “flash lamp” sintering, is very difficult due to the cracking and “blow off” of the ink or paste film prevalent with such a process.

There is a significant market interest for conductive metallic films/features/devices on lower cost flexible films, such as those made with polyethylene terephthalate (PET However, due to film temperature exposure limits, and poor adhesion with “flash lamp” high energy pulsed light sintering. PET is a difficult film to work with. Routinely, efforts to use a “flash lamp” to cure a copper ink film coated onto a PET substrate or film resulted in non-conductive films. The cured film would crack, and most commonly, would ablate or “blow off” due to severe cracking and poor adhesion to the film.

The ablation during photosintering is primarily caused by the rapid time scale of the conversion of light to heat. Copper nanoparticles appear black in color when their size is less than 100 nm. This black color is due to a broad, strong optical absorbance in the visible light region. When exposed to light, the nanoparticles absorb the light, and convert the energy into heat in an effort to dissipate the energy. The photosintering process involves exposing a surface to an intense light source. Copper has a high heat capacity and thermal conductivity, meaning it can both absorb a lot of energy in the form of heat and can also transfer this heat away very quickly. This creates an interesting effect whereby it takes a significant input of energy to a copper nanoparticle ink film to overcome the latent heat capacity and the transfer of heat within the film. However, due to the small size and mass of the individual particles, it is easy to overwhelm the energy requirements and quickly put too much energy into the film. If the energy input is too rapid, a film cannot evenly distribute the energy, and the nanoparticles will be ablated.

In an ideal situation, a nanoparticle film will have three energy transitions. The first transition is the threshold whereby the film, when exposed to light, first has enough energy to absorb the light and heat up. This first energy threshold is relatively low and will not cause any physical changes to the metallic film. The second transition occurs when there is sufficient heat energy to melt the particles. In this case, there is a physical transformation of the particles from a solid, to a pseudo-solid, and then to a liquid. The solid particle is the warm particle as a discrete particle. This heat conversion can occur very quickly, usually within a sub-microsecond time scale. The pseudo-solid occurs when the surface of the particle is melted due to the nanoparticles' high surface energy, but the core of the particle is still solid. In this state, particles are able to neck together and form conductive pathways as adjacent particles flow together on their surface without significant reorganization or movement of the core. The surface reorganization requires very little mass transfer and can occur very quickly, usually in a microsecond time scale. The full liquid physical state occurs when the time scale of melting is sufficiently long to allow the heat propagation to reach the center core of the nanoparticle. In this case, surface tension of the metal dominates, and the masses of adjacent particles will flow together creating a very high density film with very low porosity. The density of the film approaches the density of the bulk value of the parent metal. This usually occurs in a time scale of approximately 0.1-10 milliseconds.

The density of hulk copper is 8.96 g/cm³. To obtain a conductive copper film, it is preferable to provide sufficient energy for sufficient time to transition into the second phase. The third transition occurs when the energy level exceeds the melting of the nanoparticles into a liquid state. If the energy delivery is too fast or too intense, the intraparticle mass transfer cannot keep up with the internal mechanisms to shed heat. The primary mechanism to shed heat is the physical phase transition from solid to liquid. If the heat delivery is greater than the heat required for the phase transition, the nanoparticles will ablate from the surface. For example, if the surface reorganization timescale is approximately 5 milliseconds and a pulse light is applied at approximately 1 millisecond with an intensity that exceeds the threshold, it is likely that the film will be ablated.

Commonly, there are two techniques to increase the adhesion between the nanoparticle ink film and the substrate to prevent the film ablation: place a binder on the surface and/or place a binder in the ink.

Surface coatings of adhesion promoters provide a chemical anchor of the particles in the ink film closest to the substrate. In this case, it is assumed that the nanoparticles in the ink have a strong attractive affinity to each other and that only the interfacial particles in direct contact with the substrate require additional adhesive assistance. This process works well for UV (ultraviolet) cured materials and/or thermal sintering methods where the time scale of curing is extremely slow relative to photosintering. These processes can take seconds to hours to complete depending on the particular adhesive interface. Examples of polymeric surface coatings include polyvinyl alcohol (PVA), polyvinyl pyrolidone (PVP), and others that provide an ionic surface or hydrogen passivated surface. Other surface coatings can include chemical treatment of the surface with plasma, ozone, or other methods that change the chemical moieties that will be in direct contact with the ink film.

Placing a binder material in the ink increases the adhesion between adjacent particles within the film. Binder in the ink can increase the adhesion of the ink to the substrate but at the expense of film conductivity. Binder should be removed from the interface between the particles in the turn or they cannot connect to form conductive pathways. If not completely removed, the residue will reduce the overall density and conductivity of the film.

### BRIEF DESCRIPTION OF THE DRAWINGS

FIGS. 1A-1E illustrate embodiments of the present invention.

FIG. 2 shows a digital image of a Xenon Sinteron 2000 Photonic Curing System used for sintering/photosintering in embodiments of the present invention.

FIG. 3A shows a digital image of a nano-copper ink applied with a “wire rod drawdown” technique on as PET substrate.

FIG. 3B shows a digital image of a flash lamp gap and voltage optimization process where some areas have tape applied and some do not. After exposure(s), the tapes were removed, and the films characterized.

FIG. 3C shows it digital image of a copper film adhesion checked with as routine “tape test.”

FIG. 3D shows a digital image of a tape pushed off of the copper film during as sintering process by sintering induced/generated vapors.

FIG. 4 shows a digital image of a Kapton 11 substrate coated with copper ink, dried, “laminated,” then exposed to a flash lamp in three sections. The two overlapping areas received “double exposures,” resulting in a brighter copper film.

FIG. 5A illustrates a roll-to-roll process in accordance with embodiments of the present invention.

FIG. 5B illustrates a roll-to-roll process in accordance with embodiments of the present invention.

FIG. 6A illustrates a double-sided tape holding a film.

FIG. 6B illustrates a single-sided tape holding a film.

FIG. 6C illustrates an adhesive material securing a film.

FIG. 7 illustrates weights/bars/magnets holding a film,

FIG. 8A illustrates a vacuum platen bolding a film.

FIG. 8B illustrates a vacuum platen holding a film to a substrate with holes.

FIG. 9 illustrates dried “fluid” materials serving as a film.

### DETAILED DESCRIPTION

In order to maintain film density and conductivity while providing sufficient adhesion, there needs to be consideration for maintaining the adhesive promoter outside the surface coating film. Embodiments described herein implement placement of a cover film on top of a dried copper nanoparticle film. The cover layer acts to provide a thermal transfer buffer to decrease heat loss to the outside environment, inhibit a residue from remaining inside the resulting film, and confine any inter-particle motion in the film to the X,Y plane inhibiting ablation in a Z direction.

During a “flash lamp” curing parameter optimization study of dried copper ink film on a flexible substrate, a substrate was secured to a thick paper support with strips of translucent tape at the edges. It was noticed that after exposure to the flash lamp, the edges of the substrate under the tape yielded a copper film. When the tape was removed, a conductive copper film remained at those edges. Prompted by this observation, tape was pressed smoothly over a dry, pre-sintered copper ink film. Upon exposure to a flash lamp, the brown/black-colored copper ink was cured into a conductive, copper-colored film with good adhesion to the substrate. Several different types of tapes were compared with similar results. The tape barrier produced an environment that captures the vapor gases released during the flash lamp curing process, forming a “pocket,” or “vapor pillow,” over the cured film. This feature also reduced operator and environmental exposure risk to the vapors and “blown off particles.” Studies showed that with the same sintering parameters (e.g., dried ink film thickness, distance between lamp and ink film, lamp voltage power, puke width, etc.), different tapes yielded noticeably different sintering results. Thus, different tape thicknesses, levels of translucence or opacities, coatings, adhesives, etc. may be used as tools to optimize the sintering process (i.e., vary the characteristics of the sintering process and the resultant conductive film qualities). Consequently, this technique of tape lamination may be used as a new tool for flash lamp sintering parameter optimizations.

The addition of a laminated cover on top of as dried ink can be used to alter the moisture content available to the surface of the metallic ink. In addition, certain adhesive materials (compositions) may be utilized in the sintering process to provide chemical functionalization that modifies the oxidation or reduction of the metallic film.

In addition to the foregoing properties of encapsulation, the laminated cover tape can be used to alter the thermal transport characteristics of the sintering process. For example, the tape can be used to adjust how quickly the ink sinters by acting as a thermal insulator and/or heat spreader. The tape can also be used to slow the cooling rate by acting as a heat blanket thereby inhibiting radiative heat loss into the local environment. In previous experiments, it was determined that photosintering works well on a substrate possessing a low thermal conductivity. This low thermal conductivity focuses the generated heat into the metal film and inhibits heat loss into the underlying substrate.

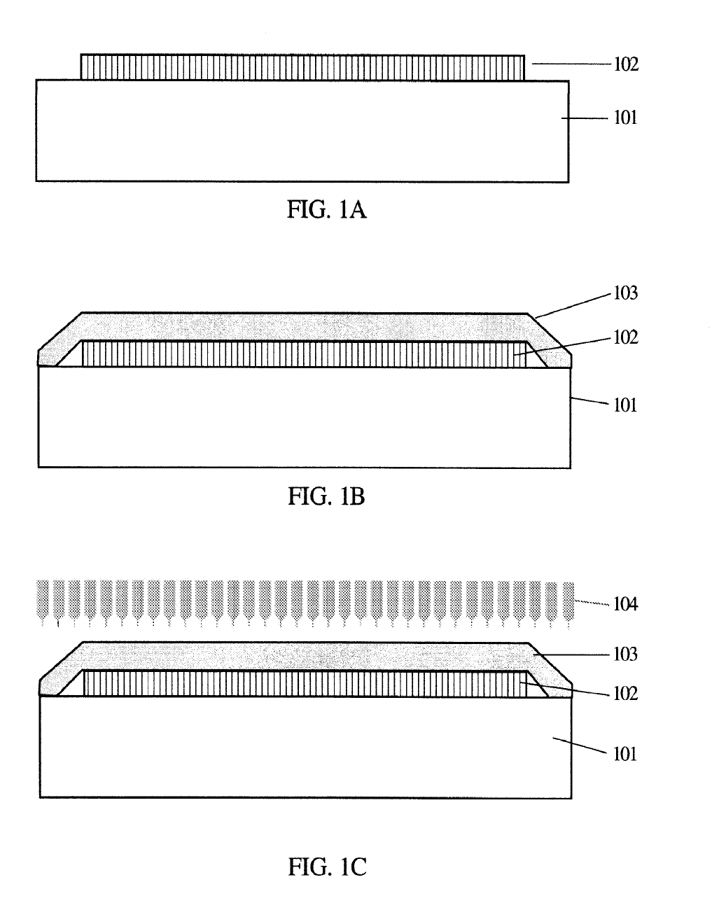

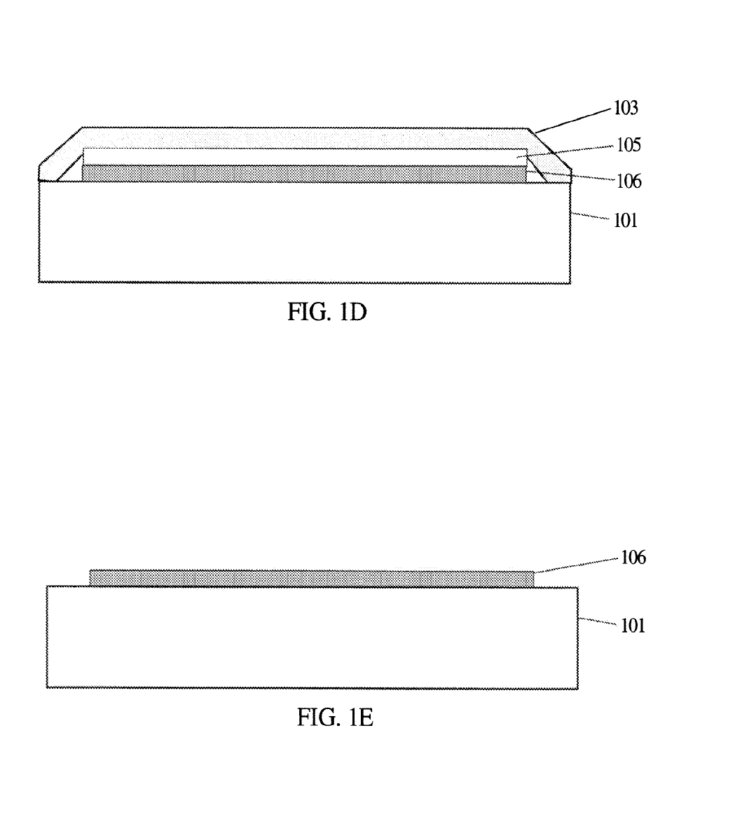

Referring to FIGS. 1A-1E, a substrate 101 (e.g., a PET material) is coated with a metallic ink or paste 102 (e.g., a nano-copper ink), and the tape lamination technique described herein utilized for producing a continuous and conductive copper film. In FIG. 1A, a metallic ink or paste 102 is applied to the substrate 101, and dried, such as with application of heat. In FIG. 1B, a film 103 is laminated over the dried ink film. The laminated film 103 may be a tape as described herein, or any other laminated film performing an equivalent function, including the alternatives described herein. In FIG. 1C, the metallic ink or paste film 102 is “flashed” with a high energy pulsed light 104 through the laminated film 103. Such a pulsed light 104 may come from a flash lamp curing system, or any other system capable of sintering and/or photosintering the metallic ink or paste film 102. FIG. 1D shows that the metallic ink or paste film 102 is sintered to produce a conductive film 106. The exhaust vapor from the sintering process produces a “pocket” or “pillow” 105 between the laminated film 103 and the sintered metallic ink or paste 106. In FIG. 1E, the laminated film 103 is removed leaving the cured metallic ink or paste film 105 attached to the substrate 101.

A stark difference was noticed between laminated and non-laminated metallic ink or paste films exposed with a flash lamp curing system. Instead of the usual cracked or “blown off” copper film, film cracking was greatly reduced, and it was possible to select process parameters that yielded continuous, conductive films 106 with secure adhesion to the substrate 101 (e.g., PET).

FIG. 2 shows a digital image of a Xenon Sinteron 2000 Photonic Curing System, which may be utilized for sintering/photosintering processes described herein. Any other system capable of performing in an equivalent manner to sinter and/or photosinter metallic inks or pastes as described herein may be utilized.

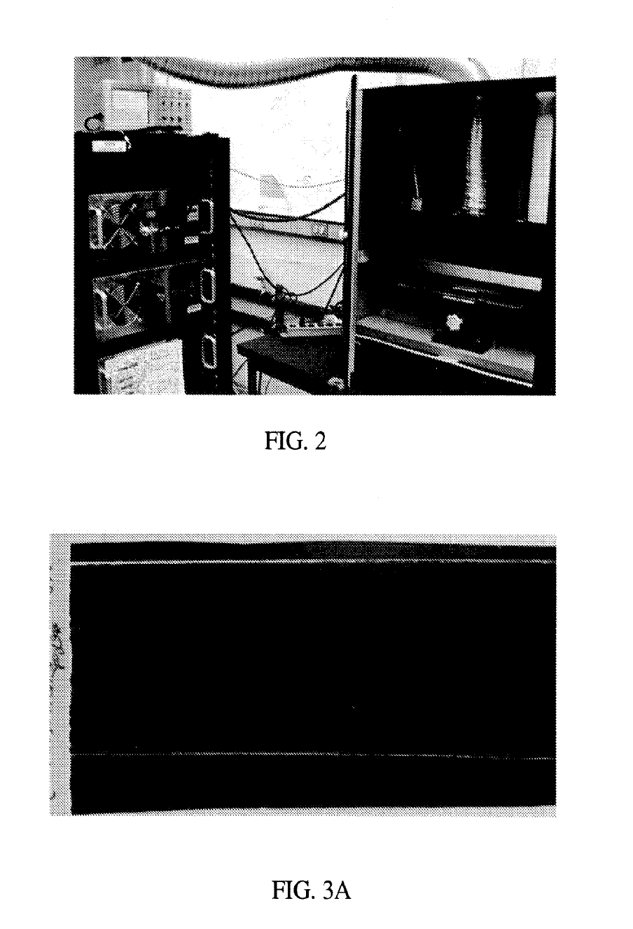

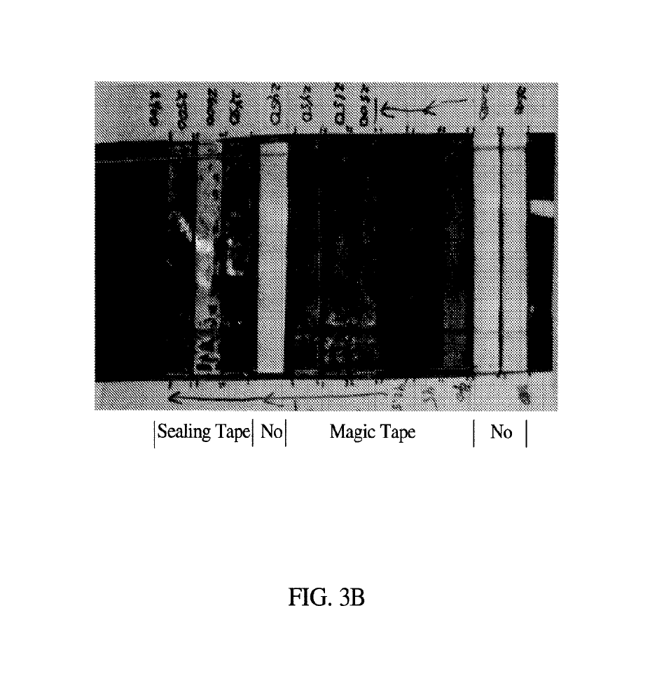

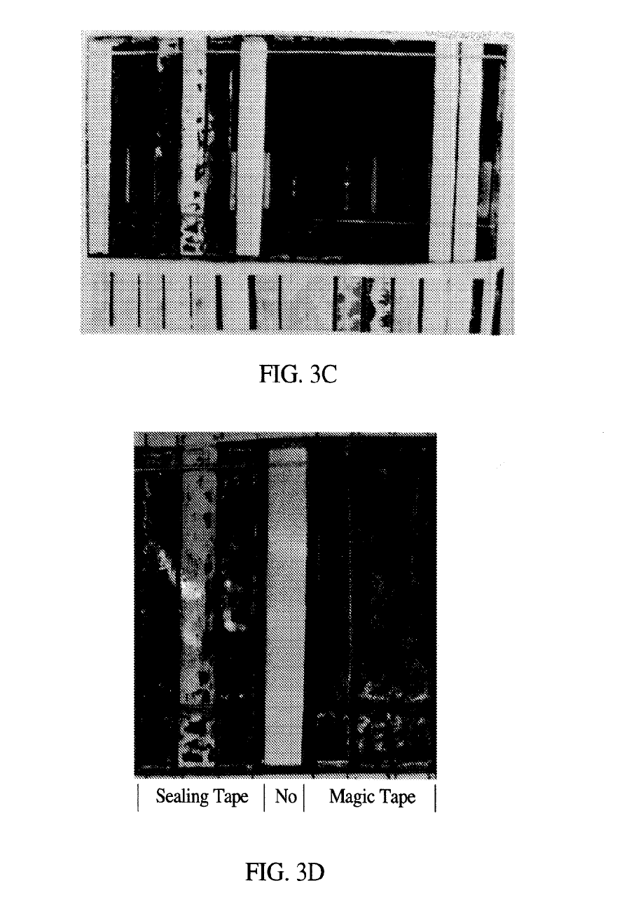

FIG. 3A shows a digital image of a nano-copper ink applied to a substrate using a “wire rod drawdown” technique onto a PET substrate. FIG. 3B shows a digital image of how flash lamp gap and voltage optimization and variation may be performed using embodiments of the present invention. The image shows some areas of the substrate with tape applied and some without. After one or more exposures, the tapes were removed, and the films were characterized. This is shown in FIG. 3C. The copper film adhesion to the substrate was checked with a routine “tape test.” The sample was inspected with a microscope, and the thickness and sheet resistance measurements were taken. The “vapor atmosphere pillow/cushion” effect described above with respect to FIG. 1D is evident in the digital image shown in FIG. 3D. Additionally, for the specimen in the sample with the label of “NO”, where no tape was applied, it is apparent that the copper film “blew off” the substrate.

An obtained sheet resistance for these copper films deposited and sintered on PET was 0.19 ohms/sq. Additionally, multiple exposures may be performed prior to removing the laminated tape to continue the sintering process to further reduce the sheet resistance of the copper film.

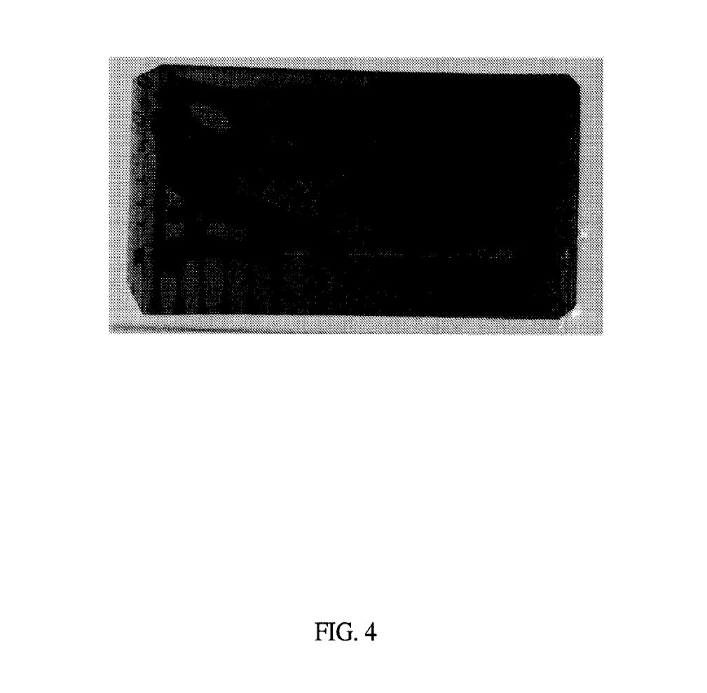

Referring to FIG. 4, a Kapton H substrate was coated with copper ink, dried, laminated with tape, then exposed in three sections. The two overlapping areas received double exposures, resulting in a brighter copper film.

In the following embodiments, metallic ink, or paste, is applied to a substrate, and the ink layer may be patterned according to a specified design. Alternatively, a paste instead of an ink may be used. This ink layer may be thermally dried (e.g., in air), and covered with adhesive tape. In embodiments, the sample is photosintered. These embodiments may be implemented in manners similar to FIGS. 1A-1E.

In a first example, the tape serves to mechanically hold the film together such that the rapid evaporation of organic components does not ablate the film from the substrate. Once the metallic layer is sintered the tape is removed.

In another example, metallic ink is applied to a substrate. The ink layer may be patterned according to a specified design. The ink layer may be thermally dried (e.g., in air). The ink layer is covered with adhesive tape. In embodiments, the sample is photosintered. The tape serves to prevent air from reaching the surface, eliminating (or at least decreasing) oxidation of the metallic film during sintering. Once the metallic layer is sintered, the tape is removed.

In another example, metallic ink is applied to a substrate. The ink layer may be patterned according to a specified design. The ink layer may be thermally dried (e.g., in air). The ink layer is covered with adhesive tape. In embodiments, the sample is photosintered. The rapid evaporation of organic components during the photosintering is captured by the tape layer that seals the edges outside the photosintering area. The organic components decompose and maintain a reducing environment to prevent (or at least inhibit) the oxidation of the metallic layer. Once the metallic layer is sintered, the tape is removed.

In another example, metallic ink is applied to to substrate. The ink layer may be patterned according to a specified design. The ink layer may be thermally dried (e.g., in air). The ink layer is covered with an adhesive tape cover that is essentially optically transparent. In embodiments, the sample is photosintered. The tape is thermally conductive. The tape serves to spread the heat across the metallic film increasing the uniformity of the film properties. Once the metallic layer is sintered, the tape is removed.

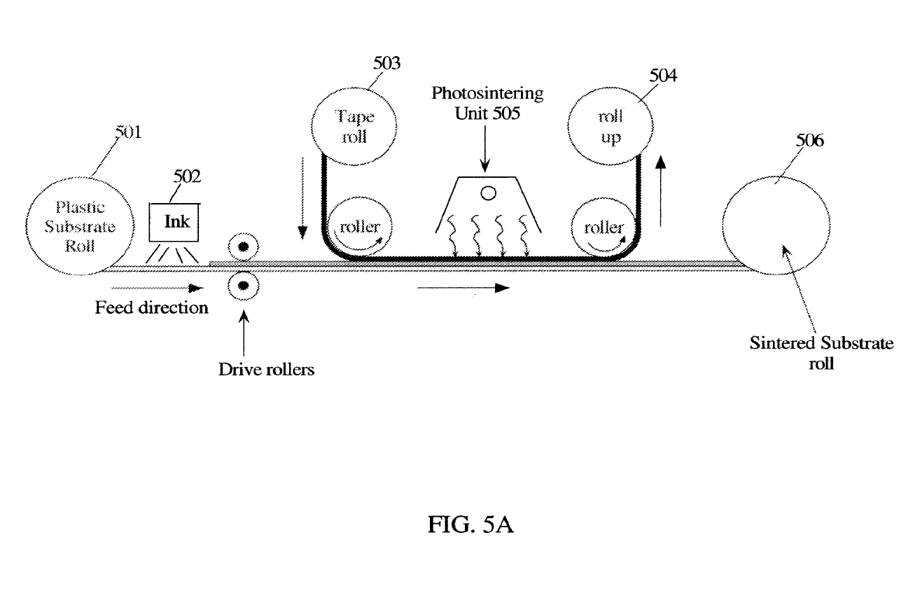

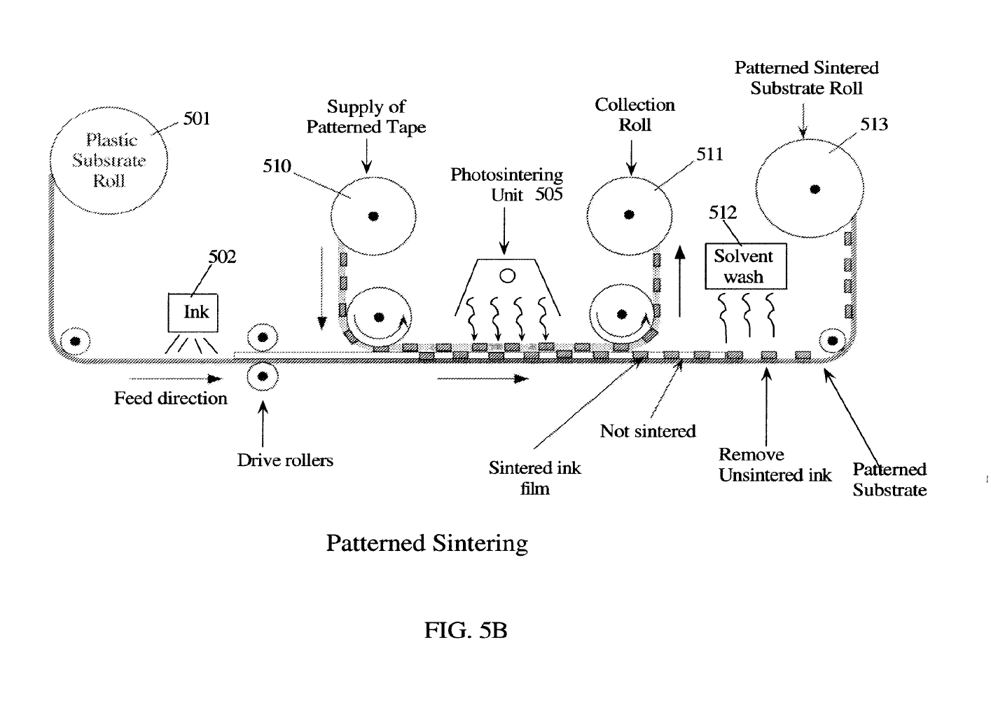

In another example, metallic ink is applied to a substrate. The ink layer may be patterned according to a specified design. The ink layer may be thermally dried (e.g., in air), The ink layer is covered with an adhesive tape. These three layers are processed using a roll-to roll technique (e.g., at high speed). In embodiments, the sample is photosintered. The tape serves to mechanically hold the film together such that the rapid evaporation of organic components does not ablate the film from the substrate. Once the metallic layer is sintered the tape is removed (e.g., using a peel-film separation technique). The adhesive tape layer can be collected on a roll and re-used in a subsequent process. For example, referring to FIG. 5A, the substrate may be rolled from a plastic roll supply 501 in a feed direction and as driven by various drive rollers to pass underneath a metallic ink dispensing unit 502, which deposits as metallic ink or paste onto the plastic substrate. Another rolled supply 503 contains the laminating tape, which is rolled onto or over the plastic substrate, which has had the metallic ink, or paste applied thereon, and passed underneath a sintering, and/or photosintering unit 505. The tape is then removed and collected onto a roll 504, while the substrate with the sintered/photosintered conductive ink or paste thereon is collected in a final roll 506.

In another example, metallic ink is applied to a substrate. The ink may be cured using photosintering at a specific wavelength. The ink layer may be thermally dried (e.g., in air). The ink layer is covered with adhesive tape whereby the tape is colored to effectively filter out wanted or unwanted wavelengths of light. Once the metallic, layer is sintered, the tape is removed.

In another example, metallic ink is applied to a substrate. The ink layer may be thermally dried (e.g., in air). The ink layer is covered with adhesive tape that may be patterned according to a specified design. These three layers are processed using a roll-to roll technique (e.g., at high speed). In embodiments, the sample is photosintered. The design creates an effective mask of the light, and the resulting metallic film takes the pattern according to the design on the tape. The non-sintered ink may be easily washed off the substrate leaving the sintered ink behind. This design may be re-used. As an example, a process similar to what was described above with respect to FIG. 5A is performed with some variations. Again, the plastic substrate is provided from a supply roll 501 and fed underneath a metallic ink or paste depositing unit 502. Then a supply of tape which has a pattern according to a specified design as noted above is provided from a supply roll 510 to be positioned onto the plastic substrate with the conductive ink or paste to thereby be sintered/photosintered by the unit 505. The patterned tape or other type of laminating film is then collected on roll 511. The plastic substrate will thereby have portions with metallic ink or paste that has been sintered/photosintered, and portions that have not. A solvent wash 512 may be utilized to remove the ink or paste that was not sintered from the substrate leaving a patterned conductive trace on the plastic substrate which is collected on roll 513.

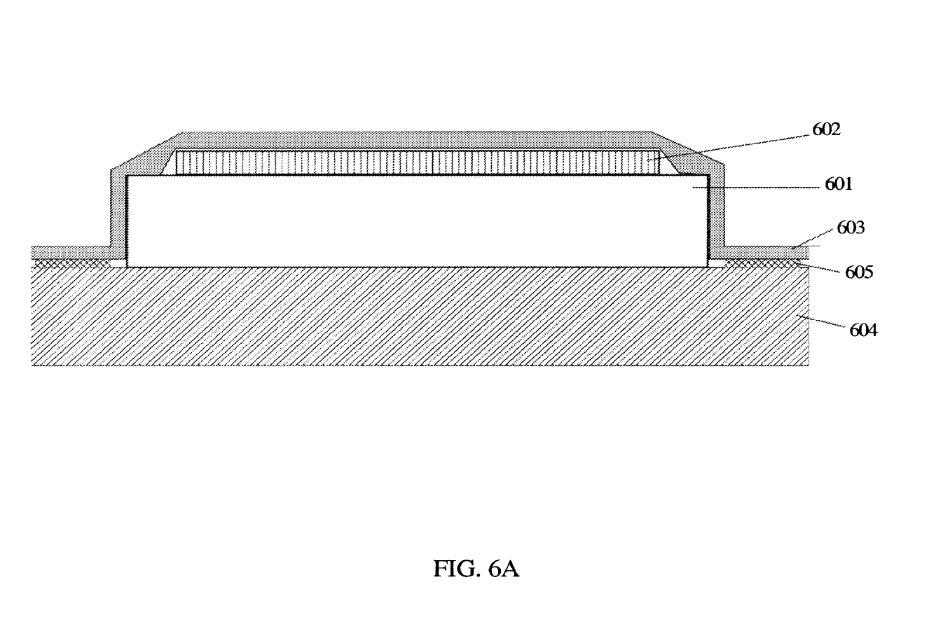

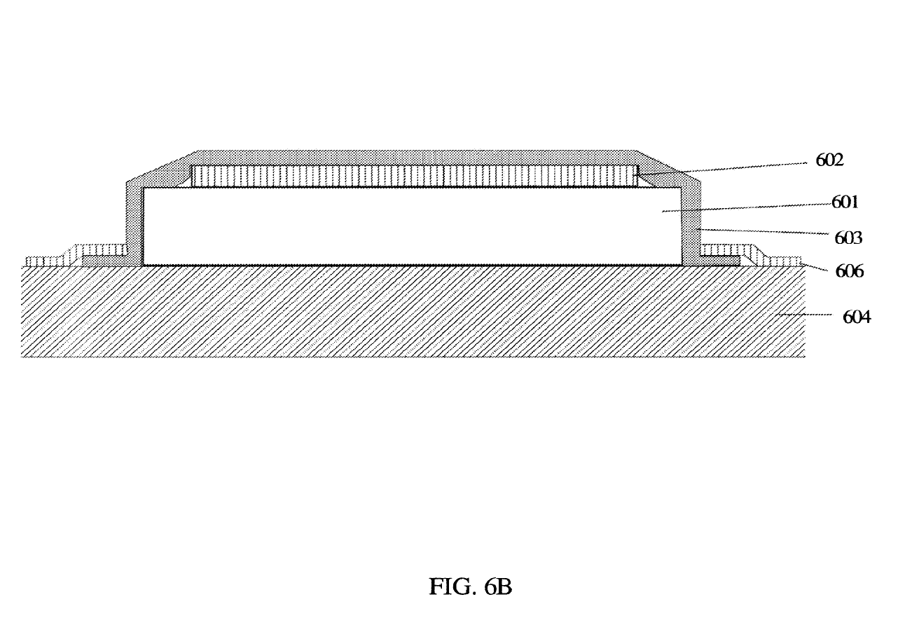

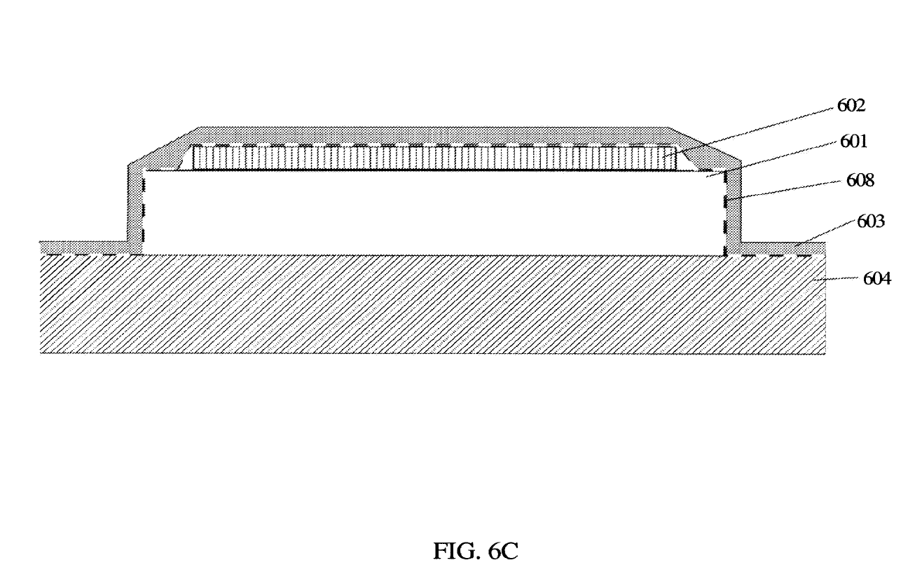

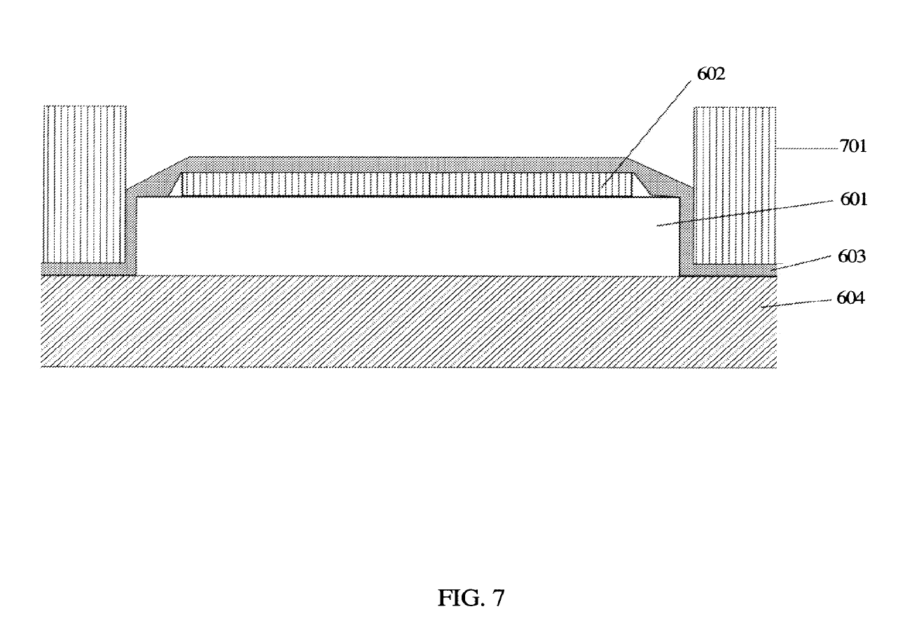

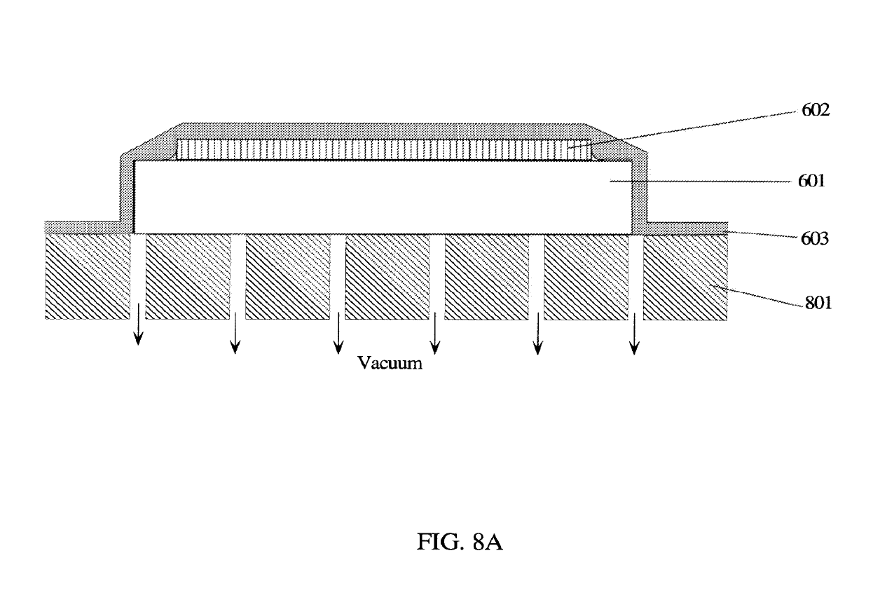

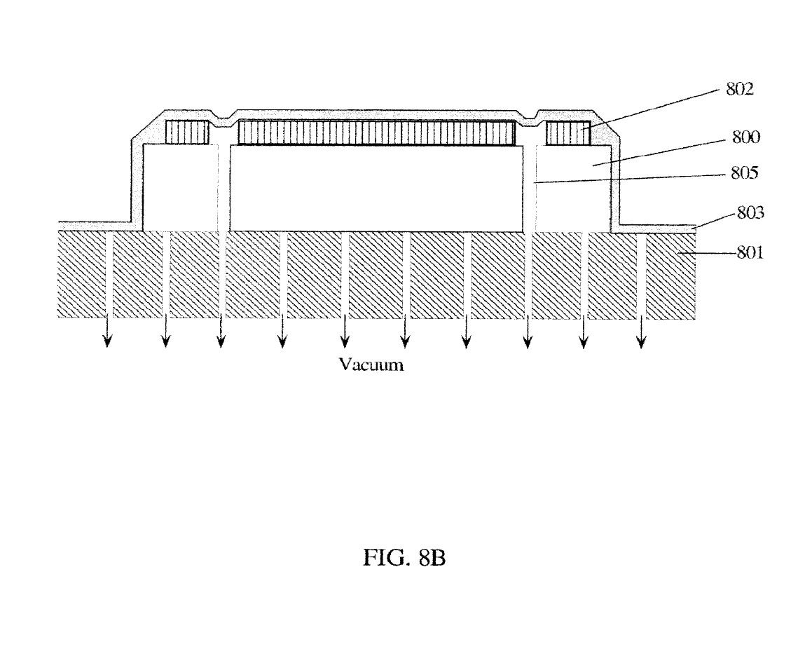

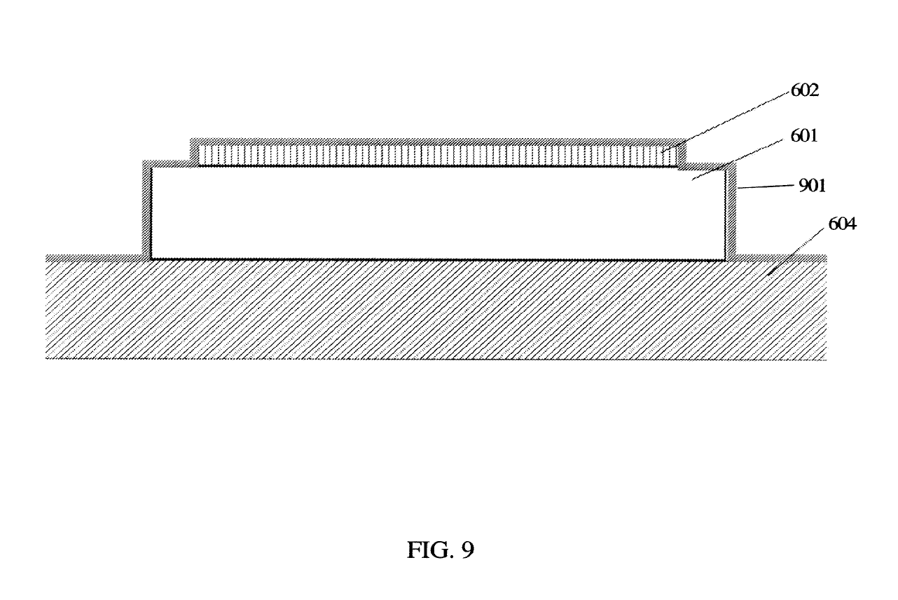

Referring to FIGS. 6A-6C, 7, 8A-8B, and 9, different films may be attached to the substrate 601. These films may be non-adhesive and sealed (e.g., tightly) to the substrate 601 containing the ink layer 602 (e.g., using adhesives, vacuum, magnetic field, or weights). For example, in FIG. 6A, there is shown a substrate 601, possibly on another substrate or platen 604. The metallic ink or paste 602 is applied or deposited to the substrate 601, and a non-adhesive laminate film 603 applied over this composite, and held down to the substrate 604 by a double-sided tape or adhesive 605. FIG. 6B shows a similar configuration with the non-adhesive film 603 held down to the substrate 604 by a single-sided tape 606. FIG. 6C shows an adhesive material utilized to secure the non-adhesive laminate film 603 to the metallic ink or paste 602 and/or substrate 601 and/or substrate 604. In FIG. 7, some other type of means is used to hold down the non-adhesive laminate film 603, such as weights/bars/magnets 701. In FIG. 8A, a vacuum platen 801 with a vacuum force applied thereto holds down the non-adhesive film 603, which may also hold down the substrate 601. FIG. 8B shows a similar configuration, but in this case the substrate with the metallic ink or paste 802 thereon is also perforated 805 with vias or holes in the substrate 800 for allowing the vacuum three to also hold down the non-adhesive film 803 over the metallic ink or paste 802, which is also patterned with the vias or holes.

The non-adhesive film or laminate material may comprise a thin silicone rubber material or sheet, which is optically transparent/translucent, including, with or without minimal UV inhibitors, and all the other characteristics described herein as alternatives for such a laminate film for use in embodiments of the present invention. In the foregoing embodiments, the metallic ink, or paste is sintered/photosintered, and it is possible in these embodiments that the released vapors are captured during the exposure process within a “pocket” or “pillow” produced between the sintered/photosintered material and the silicone sheet.

FIG. 9 illustrates embodiments where a liquid laminate material 901 is applied over the metallic ink, or paste layer 602 and/or substrate 601 and/or substrate 604. Such a liquid laminate 901 may be dried (e.g., thermally in air). The dried laminate may be flexible and/or optically transparent or translucent, and with or without minimal ultraviolet inhibitors. Such materials may comprise polymers such as polyurethane, PET, and PVC. As before, the metallic ink or paste is sintered/photosintered, and then the dried laminate 901 is removed (e.g., using a peel-film separation process).

Tape lamination on a dry copper ink film, followed by an optimized flash lamp procedure, has produced conductive films. An advantage of tape lamination over a tapeless process is that it essentially increases the curing parameter window, and reduces crack formation in the metallic film. Tape lamination facilitates curing of a continuous copper film on temperature sensitive substrates, such as PET, at power levels that would usually crack and/or blow of the copper film. This lamination process also improves adhesion and uniformity of the cured film.

Although nano-copper was mentioned in this disclosure, many other ink film materials could be sintered with this process.

In addition to the drawdown technique, there are other equivalent ink application techniques, including ink jet, aerosol jet, air brush, flexography, among many others that may be used. This lamination technique has been used with “blanket” films, as well as with trace features. The applied film thickness can be varied, and multiple layers may be processed onto a substrate.

In addition to a large variety of tapes (different material ingredients, thicknesses, textures, colors opacities, transparencies, translucent . . . ), other films may be used to coat or “laminate” the material to be cured, including non-adhesive films (which may be held in proximity with edge/discrete adhesives (see FIG. 6), weights/magnets (see FIG. 7), vacuum (see FIG. 8), and applied fluid films that are dried prior to curing (see FIG. 9), among others.

Many different substrate materials may benefit from this process, including flexible films, glass, and plastics, among others.

What is claimed:

1. A method for making a conductive layer on a substrate, comprising:
depositing a metallic ink or paste on the substrate;
covering the deposited metallic ink or paste with a material that is at least partially transparent to light; and
curing the deposited metallic ink or paste with a light source illuminating the deposited metallic ink or paste through the material to thereby transform the metallic ink or paste into the conductive layer.

2. The method as recited in claim 1, further comprising removing the material from covering the conductive layer.

3. The method as recited in claim 2, wherein the material comprises adhesive tape.

4. The method as recited in claim 2, wherein the material is a translucent colored film.

5. The method as recited in claim 2, wherein the metallic ink or paste comprises copper nanoparticles.

6. The method as recited in claim 2, wherein the substrate is a low melting point flexible film.

7. The method as recited in claim 6, wherein the low melting point flexible film is made of

8. The method as recited in claim 2, wherein the light source illuminates the deposited metallic ink or paste through the material with a broad band light.

9. The method as recited in claim 2, wherein the light source is a flash lamp.

10. The method as recited in claim 2, wherein the curing involves as photosintering of the deposited metallic ink or paste with the light source.

11. The method as recited in claim 1, wherein the substrate with the metallic ink or paste deposited thereon is moved beneath the light source using a roll-to-roll process.

12. The method as recited in claim 2, wherein the deposited metallic in or paste with the material further comprises:
depositing a liquid phase of the material over the deposited metallic ink or paste; and
drying the liquid phase of the material to produce the material that is at least partially transparent to light.

13. The method as recited in claim 2, further comprising drying the deposited metallic ink or paste previous to covering the deposited metallic ink or paste with the material.

14. The method as recited in claim 2, wherein the material is removed from covering the conductive layer by vapors generated under the material by the curing of the metallic ink or paste.
